(19) United States
(12) Patent Application Publication
(10) Pub. No.: US 2024/0379983 A1
(43) Pub. Date: Nov. 14, 2024

(54) ELECTROCHEMICAL CELLS WITH SUPPORT RIBS AND MANUFACTURING METHODS THEREOF

(71) Applicant: BLOOM ENERGY CORPORATION, San Jose, CA (US)

(72) Inventors: Travis SCHMAUSS, Burlingame, CA (US); Keji PAN, Pleasanton, CA (US); Emad EL BATAWI, Aurora, CO (US); Tad ARMSTRONG, Burlingame, CA (US); Adam BYRD, Sunnyvale, CA (US)

(21) Appl. No.: 18/652,269

(22) Filed: May 1, 2024

Related U.S. Application Data
(60) Provisional application No. 63/464,879, filed on May 8, 2023.
(60) Provisional application No. 63/601,836, filed on Nov. 22, 2023.

(51) Int. Cl. H01M 8/1226; C25B 9/23; C25B 9/63; C25B 9/65; C25B 13/02; C25B 13/07; H01M 8/0258; H01M 8/0273; H01M 8/0282; H01M 8/12

(52) U.S. Cl. CPC H01M 8/1226; C25B 9/23; C25B 9/63; C25B 9/65; C25B 13/02; C25B 13/07; H01M 8/0258; H01M 8/0273; H01M 8/0282; H01M 2008/1293

(57) ABSTRACT

An electrochemical cell includes an electrolyte layer, an anode electrode disposed over a first surface of the electrolyte layer, a ceramic anode support laterally surrounding the anode electrode and embedded in the anode electrode, such that a recess configured to receive a seal is located above a periphery of the ceramic anode support, and a cathode disposed over a second surface of the electrolyte layer.

### FIELD

Aspects of the present disclosure relate generally to electrochemical cells, and particularly to electrochemical cells including support ribs.

### BACKGROUND

A typical solid oxide fuel cell includes a ceramic electrolyte layer disposed between an anode electrode and a cathode electrode. In general, thin electrolyte layers are desired to provide high ionic conductivity. However, thin electrolyte layers may be damaged during stack manufacturing, reduction-oxidation cycling, and/or thermal cycling.

### SUMMARY

According to various embodiments, an electrochemical cell includes an anode support, an anode electrode disposed on the anode support, an electrolyte layer disposed on the anode electrode, and a cathode electrode disposed on the electrolyte layer. The anode support includes a cermet matrix including a nickel phase and a ceramic phase, and ceramic support ribs disposed in the matrix.

According to various embodiments, an electrochemical cell comprises an anode electrode; a cathode electrode; and an electrolyte disposed between the anode electrode and the cathode electrode. The electrolyte comprises a base layer; a first support layer disposed on a first surface of the base layer and comprising first apertures that expose portions of the first surface of the base layer; and a second support layer disposed on a second surface of the base layer and comprising second apertures that expose portions of the second surface of the base layer.

According to various embodiments, a method of forming an electrochemical cell comprises forming a support by forming ceramic support ribs and forming a cermet matrix between the ceramic support ribs; forming an anode electrode over the support; forming a ceramic electrolyte over the anode electrode; and forming a cathode electrode over the ceramic electrolyte.

According to various embodiments, an electrochemical cell includes an electrolyte layer, an anode electrode disposed over a first surface of the electrolyte layer, a ceramic anode support laterally surrounding the anode electrode and embedded in the anode electrode, such that a recess configured to receive a seal is located above a periphery of the ceramic anode support, and a cathode disposed over a second surface of the electrolyte layer.

According to various embodiments, a method of forming an electrochemical cell comprises forming a first functionally graded anode (FGA) layer over a first surface of an electrolyte layer, such that a peripheral region of the top surface of the electrolyte layer is exposed outside of the first FGA layer; forming a ceramic anode support comprising a seal frame disposed on the peripheral region of the electrolyte layer and a reinforcement structure disposed on a top surface of the first FGA layer; forming a second FGA layer on the first FGA layer exposed in the reinforcement structure; and forming a cathode over a second surface of the electrolyte layer.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a perspective view of an electrochemical stack, according to various embodiments of the present disclosure, and FIG. 1B is cross-sectional view of a portion of the stack of FIG. 1A.

FIG. 2A is an exploded perspective view of an electrolyte containing support ribs, according to various embodiments of the present disclosure, and FIG. 2B is a cross-sectional view of a portion of the electrolyte of FIG. 2A.

FIGS. 3A-3C are cross-sectional views of portions of alternative electrolytes containing support ribs, according to various embodiments of the present disclosure.

FIGS. 4A-4D are cross-sectional views of portions of electrochemical cells, according to various embodiments of the present disclosure.

FIG. 5A is an exploded perspective view of an anode containing support ribs, according to various embodiments of the present disclosure, and FIG. 5B is a cross-sectional view of a portion of the anode of FIG. 5A.

FIG. 6A is an exploded perspective view of an alternative anode containing support ribs, according to various embodiments of the present disclosure, and FIG. 6B is a cross-sectional view of a portion of the anode of FIG. 6A.

FIG. 7 is a cross-sectional view of a portion of an anode supported electrochemical cell, according to various embodiments of the present disclosure.

FIG. 8 is a cross-sectional view of a portion of a co-supported electrochemical cell, according to various embodiments of the present disclosure.

FIG. 9 is a flow diagram depicting method steps for manufacturing an electrochemical cell with support ribs, according to various embodiments of the present disclosure.

FIG. 10A is a cross-sectional view of an anode supported solid oxide electrochemical cell, according to various embodiments of the present disclosure. FIG. 10B is an anode-side view of the electrochemical cell of FIG. 10A.

FIGS. 11A-11E are cross-sectional and anode-side views illustrating steps in a method of forming the electrochemical cell of FIG. 10A, according to various embodiments of the present disclosure.

FIG. 12 is a cross-sectional view of the anode supported solid oxide electrochemical cell of FIG. 10A located in an electrochemical cell stack.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be a hydrogen (H₂) or a hydrocarbon fuel, such as methane, natural gas, pentane, ethanol, or methanol. The fuel cell, operating at a typical temperature between 750° C. and 950° C., enables the transport of negatively charged oxygen ions from the cathode flow stream to the anode flow stream, where the oxygen ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a solid oxide electrolyzer system, water (e.g., steam) is separated into hydrogen and oxygen by applying a voltage across the electrolyzer cells.

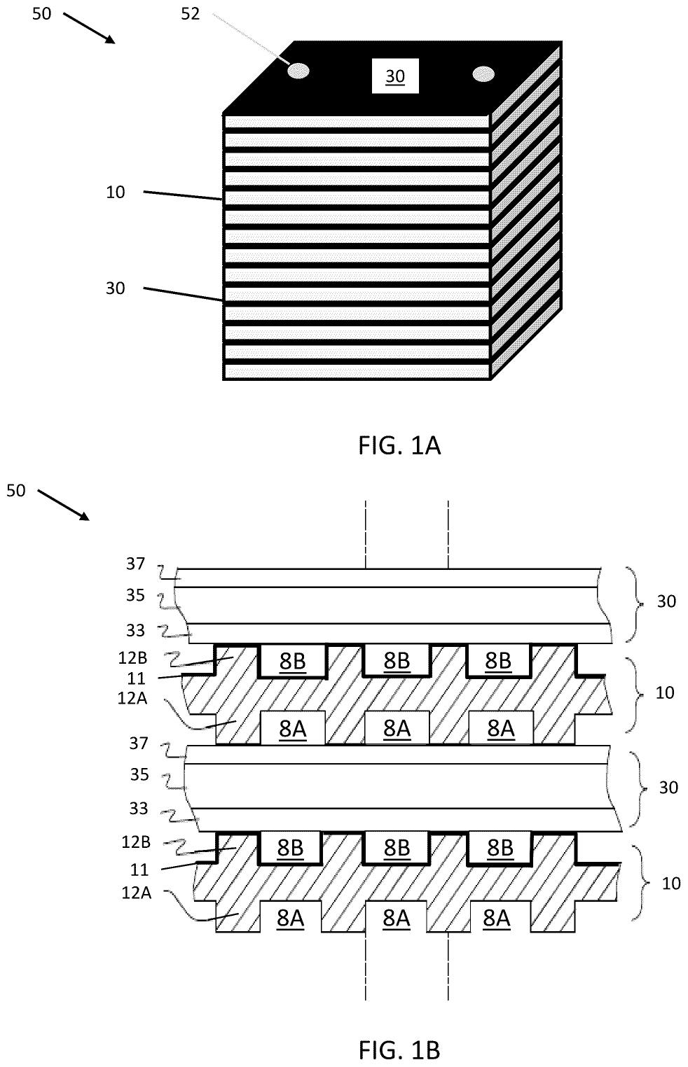

FIG. 1A is a perspective view of an electrochemical cell stack 50, and FIG. 1B is a sectional view of a portion of the stack 50, according to various embodiments of the present disclosure. In the embodiments below, the stack 50 is described as being operated as a solid oxide fuel cell (SOFC) stack 50. However, it should be noted that the stack 50 may also be operated as an electrolyzer (e.g., a solid oxide electrolyzer cell (SOEC) stack). Referring to FIGS. 1A and 1B, the stack 50 includes electrochemical cells 30, such as fuel cells (e.g., SOFCs) or electrolyzer cells (e.g., SOECs), separated by interconnects 10. In the embodiments below, the electrochemical cells 30 are described as being fuel cells. Referring to FIG. 1B, each fuel cell 30 comprises a cathode electrode 33, a solid oxide electrolyte 35, and an anode electrode 37. However, it should be noted that the electrochemical cells 30 may alternatively comprise electrolyzer cells which include a solid oxide electrolyte 35 located between an air electrode 33 and a fuel electrode 37.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above described materials.

Fuel cell stacks 50 are frequently built from a multiplicity of SOFC's 30 in the form of planar elements, tubes, or other geometries. Although the fuel cell stack in FIG. 1A is vertically oriented, fuel cell stacks may be oriented horizontally or in any other direction. Fuel and air may be provided to the electrochemically active surface, which can be large. For example, fuel may be provided through fuel holes (e.g., fuel riser openings) 52 formed in each interconnect 10. The fuel holes 52 may be aligned to form fuel conduits that extend through the stack 50.

Each interconnect 10 electrically connects adjacent fuel cells 30 in the stack 50. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent iron, optionally 1 or less weight percent yttrium and balance chromium alloy and may electrically connect the anode or fuel-side of one fuel cell 30 to the cathode or air side of an adjacent fuel cell 30. An electrically conductive contact layer, such as a nickel layer or mesh, may be provided between anode electrodes 37 and a fuel side of each interconnect 10. An electrically conductive protective layer 11, such as lanthanum strontium manganate and/or manganese cobalt spinel, may be provided on at least an air side of each interconnect 10.

Electrochemical cells, such as SOFCs and SOECs, are typically supported in order to increase mechanical stability and reliability. For example, supported cells include electrode-supported cells, electrolyte-supported cells, and co-supported cells. Electrolyte-supported cells include a relatively thick electrolyte layer upon which relatively thin electrodes are formed. Electrode supported cells include a relatively thick supporting electrode (e.g., anode) to provide structural support, and co-supported cells may include a relatively thick supporting electrode and a relatively thick electrolyte.

Electrolyte-supported cells offer numerous advantages including improved sealing resulting from a dense electrolyte perimeter and reduction stability due to having a thin anode. However, electrolyte-supported cells often exhibit higher area specific resistance (e.g., Ohmic resistance) values than electrode-supported cells because the electrolyte typically exhibits lower bulk electrical conductivity than the anode or cathode materials. For example, in electrolyte-supported solid oxide fuel cells, the ohmic resistance of the electrolyte layer may be the largest contributor to the total area specific resistance of the cell at typical operating temperatures (e.g., at about 800 to 850° C.).

Electrode-supported SOFCs and SOECs are typically produced by co-sintering a support electrode material and a coating of electrolyte material. Electrode-supported cells include anode-supported cells having a relatively thick anode and cathode-supported cells having a relatively thick cathode. Cathode-supported cells have the potential to be lightweight and lower in cost than anode-supported cells. However, processing of cathode-supported cells is difficult because the co-firing of most cathode materials in contact with an electrolyte produces insulating intermediate compounds.

The processing of anode-supported cells is comparatively simple because sintering temperatures in excess of 1300° C. can be used to achieve dense electrolytes without concern for interaction between the anode material and the electrolyte. However, anode-supported cells may suffer from redox instability, affecting the operational reliability of the cell when the anode is exposed to changing oxygen partial pressures. Redox instability is caused by the volumetric expansion of Ni to NiO within the anode, which may not be fully accommodated by the open pore space. As a result, cracks may form in the anode that may decrease steady-state performance. Severe cracks can also extend to the electrolyte, reducing Nernstian voltage.

In addition, electrode-supported cells may exhibit cambering during fabrication due to a CTE mismatch between the anode and the electrolyte, which may complicate manufacturing and/or reduce cell-to-interconnect contact. For example, a shrinkage mismatch during sintering may result in camber between the electrolyte, which may have a high green density, and the anode layers, which may have a low green density. As result, compressive stress may be applied to the electrolyte. After sintering, the camber may be further exacerbated as the cell cools.

Accordingly, various embodiments provide electrochemical cells that include support ribs. Such cells resist cambering and provide high performance and reliability.

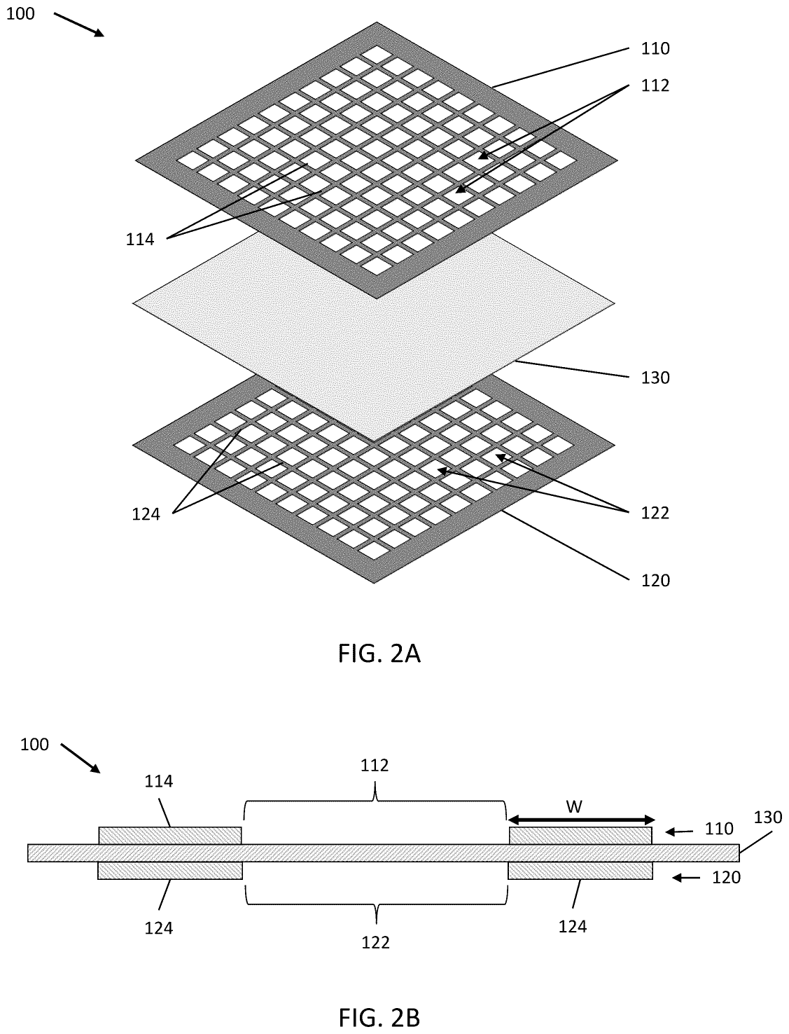

FIG. 2A is an exploded perspective view of an electrolyte containing support ribs for use in an electrolyte supported cell, according to various embodiments of the present disclosure, and FIG. 2B is a cross-sectional view of a portion of the electrolyte of FIG. 2A.

Referring to FIGS. 2A and 2B, according to various embodiments, the electrolyte 100 may be formed of an ionically conductive ceramic material, such as a doped zirconia material or a doped ceria material. For example, the electrolyte may include scandia stabilized zirconia (SSZ), yttria stabilized zirconia (YSZ), yttria-ceria-stabilized zirconia (YCSZ), ytterbia-ceria-scandia-stabilized zirconia (YbCSSZ), or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference.

The electrolyte 100 may comprise a first support layer 110, a second support layer 120, and a base layer 130 disposed therebetween. However, the present disclosure is not limited to any particular number of support layers. For example, the electrolyte 100 may include a single support layer, or more than two support layers.

Each of the layers 110, 120, 130 may have a thickness ranging from about 25 μm to about 125 μm, such as from about 50 μm to about 100 μm. However, the thicknesses of the layers 110, 120, 130 is not limited thereto. For example, the thicknesses of the layers 110, 120, 130 may be independently controlled depending on a desired electrolyte structure.

The layers 110, 120, 130 may be formed by tape casting. In particular, the tape may be cut to form the base layer 130 and may be cut and punched to form the support layers 110, 120. In particular, the support layers 110, 120 may include respective apertures 112, 122 (e.g., through holes) separated by the respective support ribs 114, 124. As shown in FIG. 2A, the apertures 112, 122 may be rectangular. However, the apertures 112, 122 are not limited to any particular geometry. For example, the apertures 112, 122 may be circular, polygonal, or the like. In various embodiments, the ribs 114, 124 may have a width W ranging from about 15 μm to about 125 μm, such as from about 25 μm to about 75 μm. However, the ribs 114, 124 may have any suitable widths. In one embodiment, the ribs 114 of support layer 110 may extend in perpendicular directions to form a square lattice of the apertures 112. Likewise, the ribs 124 of support layer 120 may extend in perpendicular directions to form a square lattice of the apertures 122.

The layers 110, 120, 130 may be stacked and laminated in a green state. The resultant structure may be debinded and sintered to form the electrolyte 100 having a continuous base layer 130 with perpendicular support ribs 114 and 124 located on opposite sides of the continuous base layer 130. As shown in FIG. 2B, in some embodiments the support layers 110, 120 may be arranged such that the apertures 112, 122 overlap one another in a vertical direction perpendicular to a plane of the base layer 130.

The apertures 112, 122 may be configured to reduce the ohmic resistance (e.g., the anode specific resistance (ASR)) of the electrolyte 100. For example, if the layers 110, 120, 130 each have a thickness of 75 μm and an ASR of about 10 Ωcm², the supported electrode may have an effective ASR of about 0.1 Ωcm², due to the presence of the apertures 112, 122. For comparison, the ASR of a similar electrolyte with a thickness of 225 μm (3 layers×75 μm) and formed of the same material, but that lacks the apertures may have an ASR of 0.225 Ωcm². Therefore, in this example, the ohmic resistance of the electrolyte 100 may be decreased by over a factor of two due to the presence of the apertures 112, 122 between the support ribs. It is noted that this example does not include the effects of activation and concentration polarization of electrodes disposed on the electrolytes, the electrode sheet resistance, or the effective contact area with adjacent interconnects.

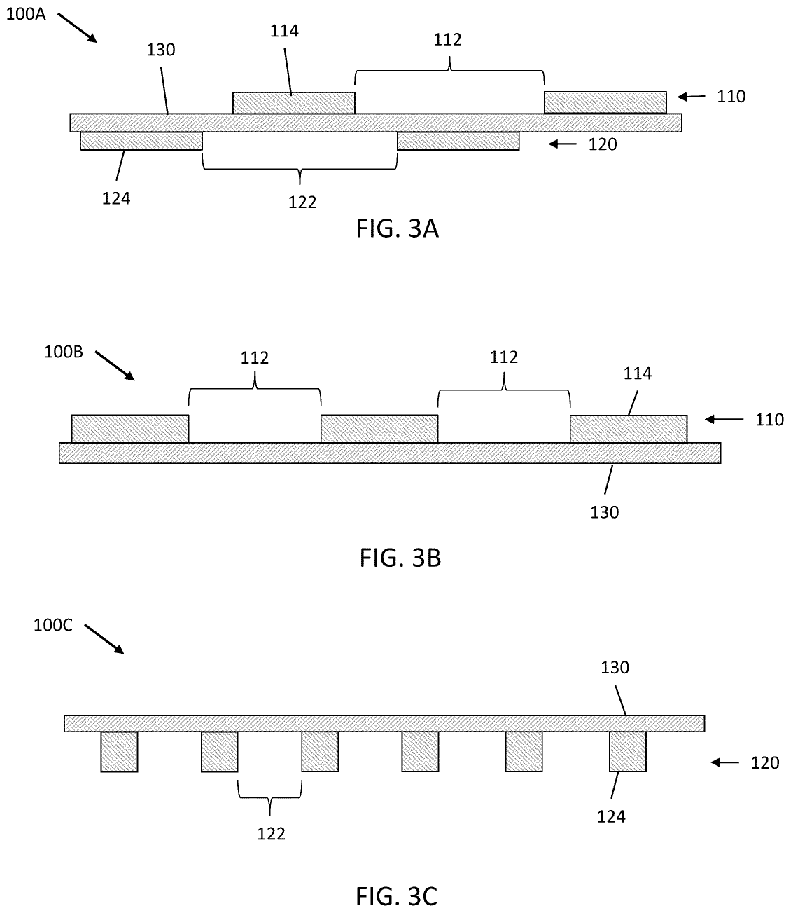

FIGS. 3A-3C are cross-sectional views of portions of alternative electrolytes 100A, 100B, 100C, according to various embodiments of the present disclosure. The electrolytes 100A, 100B, 100C may be similar to the electrolyte 100. As such, only the differences therebetween will be discussed in detail.

Referring to FIG. 3A, the electrolyte 100A may include first and second support layers 110, 120 that are asymmetrically disposed on the base layer 130. In particular, the ribs 114 of the first support layer 110 may be at least partially vertically overlapped with the apertures 122 of the second support layer 120, and the ribs 124 of the second support layer 120 may be at least partially vertically overlapped with the apertures 112 of the first support layer 110. Thus, the ribs 114 on one side of the base layer 130 are laterally offset relative to the respective ribs 124 on the opposite side of the base layer 130.

Referring to FIG. 3B, the electrolyte 100B may include a first support layer 110 disposed on a base layer 130 and may exclude the second support layer. Thus, the support ribs 114 are located on only one side of the continuous base layer 130. In some embodiments, the thickness of the ribs 114 of the first support layer 110 may be increased, as compared to the ribs 114, 124 of the supported electrolyte 100A. In particular, the increased rib thickness may compensate for the lack of a second support layer, with respect to providing support to the base layer 130.

Referring to FIG. 3C, the electrolyte 100C may include a second support layer 120 disposed on a base layer 130 and may exclude the first support layer. In some embodiments, the ribs 124 of the second support layer 120 may be taller and/or narrower than the ribs 114, 124 of the electrolyte 100A. The ribs 124 may also have a higher pitch, such that the size of the apertures 122 is comparatively reduced. In particular, the increased rib thickness and/or pitch may compensate for the lack of a first support layer, with respect to providing support to the base layer 130.

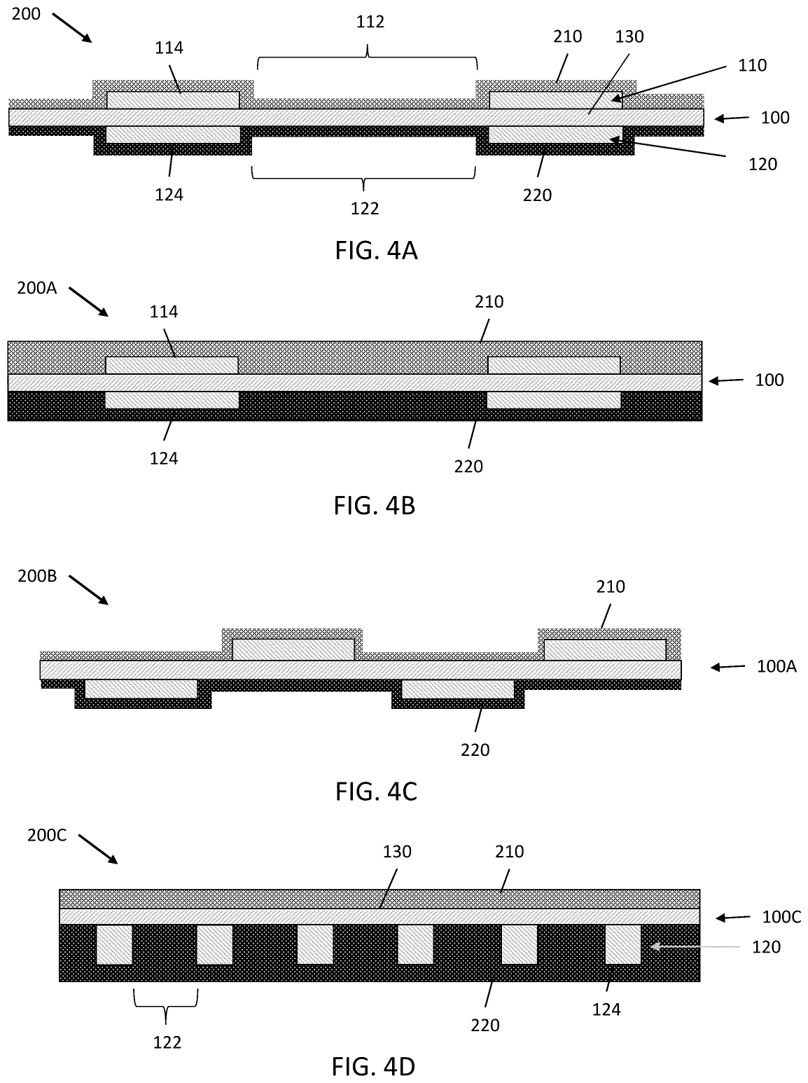

FIGS. 4A-4D are cross-sectional views of portions of electrochemical cells 200-200C, according to various embodiments of the present disclosure. Referring to FIG. 4A, the electrochemical cell 200 may include the electrolyte 100, a cathode electrode 210, and an anode electrode 220. The cathode electrode 210 and the anode electrode 220 may be disposed on opposing sides of the electrolyte 100. The cathode electrode 210 and the anode electrode 220 may be single or multi-layer structures respectively comprising a cathode material and an anode material as described above. For example, the anode electrode 220 may comprise a cermet comprising a nickel containing phase and a ceramic phase. The nickel containing phase may include nickel and/or nickel alloys and may optionally include other additional metals. The ceramic phase may comprise a stabilized zirconia, such as yttria and/or scandia stabilized zirconia and/or a doped ceria, such as gadolinia, yttria and/or samaria doped ceria. The cathode electrode 210 may comprise an electrically conductive perovskite material, such as lanthanum strontium manganite (LSM), for example.

The cathode electrode 210 and anode electrode 220 may be deposited so as to contact the base layer 130, cover the respective ribs 114, 124, and at least partially fill the depths of the respective apertures 112, 122. For example, the cathode electrode 210 and anode electrode 220 may be formed by coating cathode and anode inks on the electrolyte 100.

The cathode ceramic support ribs 114 contact the continuous portion (e.g., base layer 130) of the ceramic electrolyte 100. Except for the ribs 114 on the end of the first support layer 110, the opposing vertical sides each of the ribs 114 contact respective portions of the electrically conductive cathode electrode 210. As used herein, “vertical sides” extend perpendicular to the major surfaces of the base layer 130. The anode ceramic support ribs 124 contact the continuous portion (e.g., base layer 130) of the ceramic electrolyte 100. Except for the ribs 124 on the end of the second support layer 120, the opposing vertical sides each of the ribs 124 contact respective portions of the electrically conductive anode electrode 220, such as a cermet anode electrode 220 containing a nickel phase and a ceramic phase.

Referring to FIG. 4B, the cell 200A may be similar to the cell 200, except that the cell 200A includes a thicker cathode electrode 210 and a thicker anode electrode 220. In particular, the cathode electrode 210 and anode electrode 220 may completely fill the depths of the respective apertures 112, 122. As such, the external surfaces of the cathode electrode 210 and anode electrode 220 may be significantly more planar than the external surfaces of the cathode electrode 210 and anode electrode 220 of the cell 200. As such, the interconnect contact area of the cell 200A may be higher than that of the cell 200, and the sheet resistance of the cell 200A may be lower than that of the cell 200. However, the thicker cathode electrode 210 and anode electrode 220 of the cell 200A may increase the concentration polarization, as compared to the thinner cathode electrode 210 and anode electrode 220 of the cell 200.

Referring to FIG. 4C, the cell 200B may include the electrolyte 100A of FIG. 3A, the cathode electrode 210, and the anode electrode 220. Referring to FIG. 4D, the cell 200C may include the electrolyte 100C of FIG. 3C, the cathode electrode 210, and the anode electrode 220. The anode electrode 220 of the cell 200C may be thicker than the cathode electrode 210, in order to completely fill the anode side apertures 122 between the anode side ribs 124 and to provide a planar external surface. The cathode electrode 210 may be thinner than the anode electrode 220 and still provide a planar external surface, due to the lack of a first support layer.

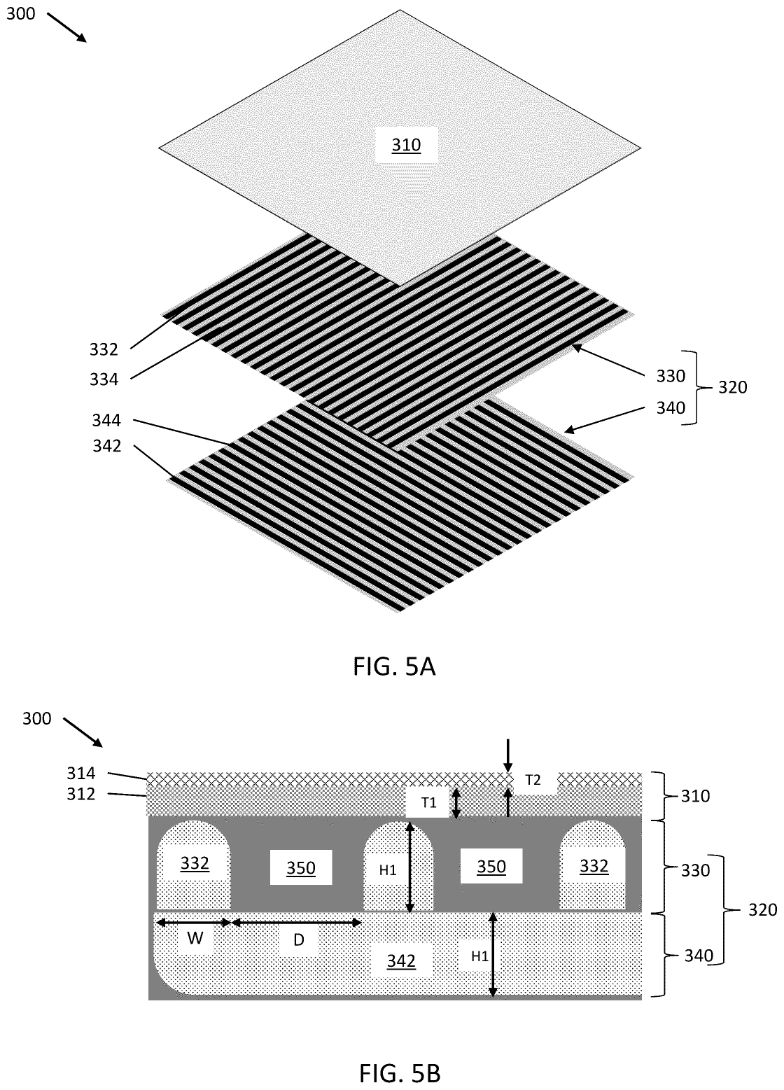

FIG. 5A is an exploded perspective view of an anode 300 containing support ribs, according to various embodiments of the present disclosure, and FIG. 5B is a cross-sectional view of a portion of the anode 300 of FIG. 5A. Referring to FIGS. 5A and 5B, the anode 300 may include a continuous anode electrode 310 disposed on an anode support 320.

The anode electrode 310 may include a nickel containing phase and an ionically conductive ceramic phase, such as SSZ, YSZ, or doped ceria, as described above. The anode electrode 310 may be a single or multi-layer structure disposed on the anode support 320. For example, the anode electrode 310 may include a first functionally graded anode (FGA) layer 312 and a second FGA layer 314. The first FGA layer 312 may include a lower ratio of the nickel containing phase to the ionically conductive phase than the second FGA layer 314.

The anode support 320 may include a first support layer 330 and a second support layer 340. The first support layer 330 may include first support ribs 332 disposed in a first matrix layer 334. The second support layer 340 may include second support ribs 342 disposed in a second matrix layer 344.

The support ribs 332, 342 may be formed of a ceramic material, such as yttria stabilized zirconia (YSZ), scandia stabilized zirconia (SSZ), yttria-scandia stabilized zirconia (YSSZ), and/or a doped ceria material, such as gadolinia, yttria and/or samaria doped ceria. The above ceramic material may be optionally blended with alumina, such as 2 to 5 mol % alumina. For example, the YSZ may comprise 3 to 4 mol % yttria stabilized zirconia to provide increased strength. In one embodiment, the YSZ may be blended with 2 to 5 mol % alumina. In one embodiment, the ceramic support ribs 332, 342 have no free metal phase, such as a free nickel phase, and have a nickel content of less than about 1 mol %, such as less than 0.5 mol %, less than 0.25 mol %, less than 0.1 mol %, such as 0 to 0.01 mol %. In some embodiments, the support ribs 332, 342 may include no nickel, or only a trace amount of nickel diffused from the matrix layers 334, 344.

The first support ribs 332 may be oriented in a first horizontal direction parallel to each other. The second support ribs 342 may be oriented in a second horizontal direction parallel to each other. The first horizontal direction is different from the second horizontal direction such that the first support ribs 332 cross the second support ribs 342. In one embodiment, the first horizontal direction may be perpendicular to the second horizontal direction. For example, the first support ribs 332 and the second support ribs 342 may extend lengthwise in perpendicular directions. The ribs 332, 342 may be laminated to form a grid structure.

The matrix layers 334, 344 may be laminated to each other to form a conductive matrix 350 surrounding the ribs 332, 342. The matrix 350 (i.e., the matrix layers 334, 344) may be formed of a cermet material having a metal phase and a ceramic phase. For example, the matrix 350 may include a nickel-containing phase and a ceramic phase. The nickel containing phase may include nickel and/or nickel alloys and may optionally include other additional metals. The ceramic phase may comprise a stabilized zirconia, such as yttria and/or scandia stabilized zirconia and/or a doped ceria, such as gadolinia, yttria and/or samaria doped ceria. In some embodiments, the matrix 350 may preferably comprise Ni-YSZ, such as nickel doped 3 to 4 molar YSZ(Ni-3-4YSZ).

In various embodiments, the matrix 350 may have a higher porosity than the anode electrode 310, since the matrix 350 is supported by the ribs 332, 342. As such, the matrix 350 may have a high amount of free space to accommodate the expansion of nickel oxide during nickel oxide-nickel metal redox reactions. As such, the matrix 350 may have a higher nickel content than conventional anodes, and thus, a higher conductivity, without compromising redox stability. For example, the matrix 350 may have a nickel content that is at least 10 mol % higher than the anode electrode 310. However, the total amount of nickel included in the anode 300 may be less than conventional anodes, due to the low nickel content of the ribs 332, 342.

The ribs 332, 342 may have a lower coefficient of thermal expansion (CTE) than the matrix 350. The inclusion of the ribs 332, 342 in the anode 300 may reduce the amount of the matrix 350 included in the anode 300. As a result, the ribs 332, 342 may reduce green body anode shrinkage. In particular, high-temperature densification of the ribs 332, 342 may prevent or reduce warping of an adjacent electrolyte, due to cooling of the higher CTE of matrix 350.

Conventional anode supported cells generally require an anode thickness of at least 300 μm, in order to prevent cell cambering and produce a suitably flat cell. However, the strengthening provided by ribs 332, 342 may allow for a significantly reduced anode thickness.

In various embodiments, the ribs 332, 342 may have a height H1 ranging from about 15 μm to about 250 μm, such as from about 20 μm to about 100 μm, from about 25 μm to about 75 μm, or from about 25 μm to about 60 μm. However, the ribs 332, 342 may have any suitable height. The heights of the ribs 332, 342 may be the same or different. The ribs 332, 342 may have widths W ranging from about 0.25 mm to about 2 mm, such as from about 0.5 mm to about 1.5 mm, from about 0.75 mm to about 1.25 mm, or about 1 mm. A distance D between the ribs 332, 342 may range from about 5 mm to about 15 mm, such as from about 7 mm to about 13 mm, from about 8 mm to about 12 mm, or from about 9 mm to about 11 mm. However, the present disclosure is not limited to any particular rib dimensions.

The first FGA layer 312 may have a thickness T1 ranging from about 7 μm to about 17 μm, such as from about 10 μm to about 14 μm, or from about 11 μm to about 13 μm. The second FGA layer 314 may have a thickness T2 ranging from about 2 μm to about 10 μm, such as from about 4 μm to about 8 μm, or from about 5 μm to about 6 μm. However, the present disclosure is not limited to any particular FGA layer thicknesses.

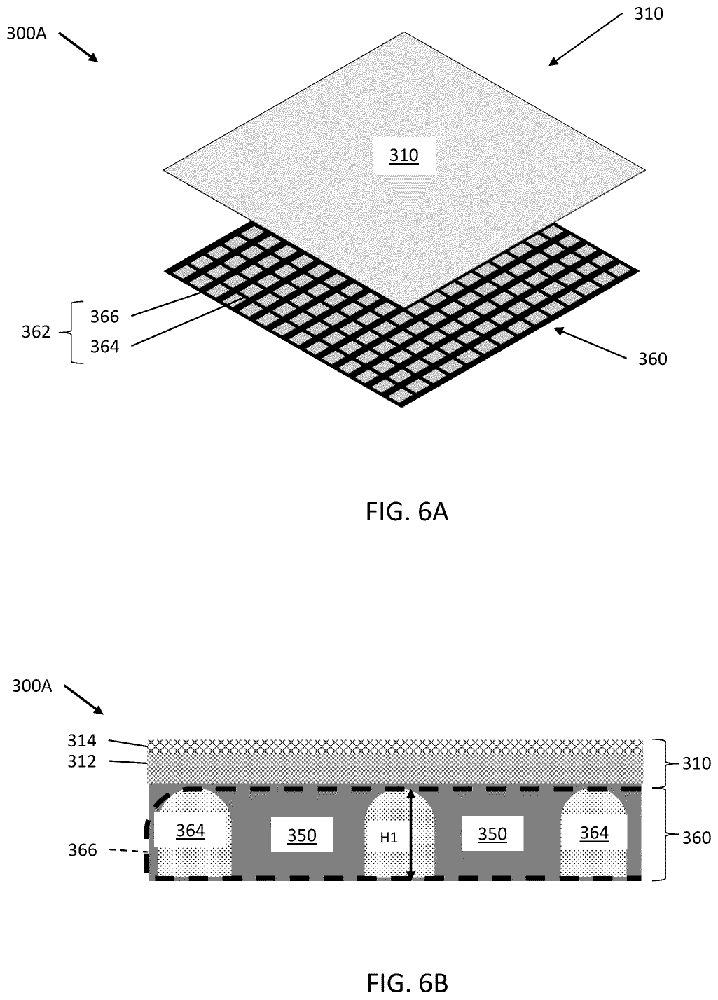

FIG. 6A is an exploded perspective view of an alternative anode 300A, according to various embodiments of the present disclosure, and FIG. 6B is a cross-sectional view of a portion of the anode 300A of FIG. 6A. The anode 300A may be similar to the anode 300 of FIGS. 5A and 5B. As such, only the differences therebetween will be discussed in detail.

Referring to FIGS. 6A and 6B, the anode 300A may include an anode electrode 310 disposed on an anode support 360. The anode support 360 may include a support grid 362 disposed in a conductive matrix 350. The support grid 362 may include coplanar first support ribs 364 and second support ribs 366 that extend lengthwise across one another. For example, the first support ribs 364 may extend orthogonally to the second support ribs 366. The conductive matrix 350 may be disposed between, around, above, and/or below the support grid 362. In some embodiments, the anode 300A may include an additional anode support layer (not shown) disposed below the support grid 362.

In various embodiments, the anode support 360 may be formed by gravure printing the support grid 362 on a support or web. Alternatively, the anode support 360 may be formed by screen printing, dispensing or ink jet printing to form the support grid 362 without the need to stack different material sheets. The conductive matrix 350 may be deposited on the support grid 362 by tape-casting using a doctor blade, for example.

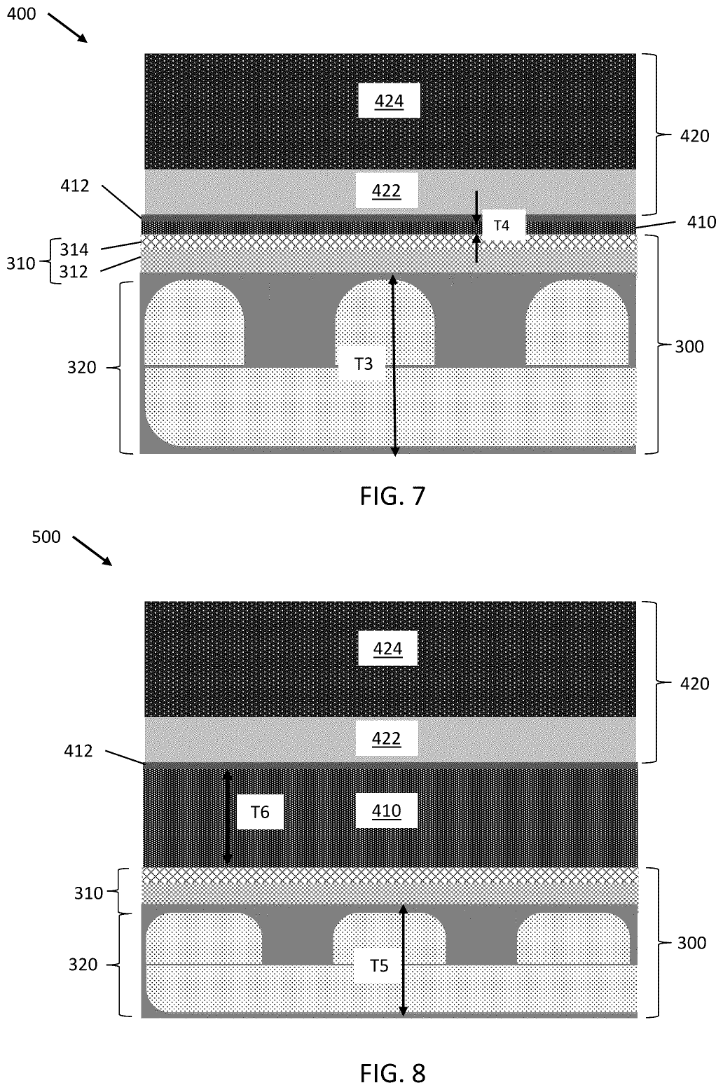

FIG. 7 is a cross-sectional view of a portion of an anode supported fuel cell 400, according to various embodiments of the present disclosure. Referring to FIG. 7, the cell 400 may include an anode 300 as described in FIGS. 5A and 5B, an electrolyte layer 410, an optional barrier layer 412, and a cathode electrode 420. The electrolyte layer 410 may be formed of an electrolyte material as discussed above and may be disposed on the anode electrode 310. The barrier layer 412 may be disposed on the electrolyte layer 410 and may be configured to prevent diffusion of cathode materials into the electrolyte layer 410.

The cathode electrode 420 may be disposed on the barrier layer 412. The cathode electrode 420 may be a single or multi-layer structure. For example, as shown in FIG. 7, the cathode electrode 420 may include a cathode functional layer 422 and a cathode contact layer 424. The cathode functional layer 422 may include a cathode catalyst, such as lanthanum strontium manganate, lanthanum strontium cobaltite, lanthanum strontium cobalt ferrite or lanthanum nickel ferrite, and the cathode contact layer 424 may include an electrically conductive material, such as lanthanum strontium manganate configured to reduce electrical resistance between the cathode electrode 420 and an adjacent component, such as an interconnect.

The anode support 320 may have a thickness T3 ranging from about 50 μm to about 400 μm, such as from about 75 μm to about 300 μm, or from about 100 μm to about 200 μm. The electrolyte layer 410 may have a thickness T4 ranging from about 2 μm to about 10 μm, such as from about 4 μm to about 8 μm, or from about 5 μm to about 7 μm. Accordingly, the relatively thick anode support 320 may support the relatively thin electrolyte layer 410.

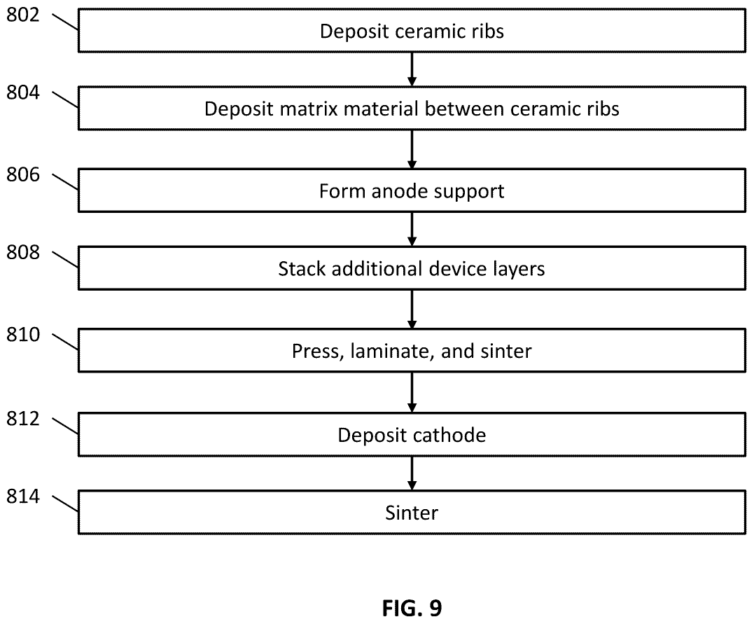

FIG. 8 is a cross-sectional view of a portion of a co-supported fuel cell 500, according to various embodiments of the present disclosure. The cell 500 may be similar to the cell 400 of FIG. 7. As such, only the differences therebetween will be discussed in detail.

Referring to FIG. 8, the cell 500 may include a relatively thin anode support 320 and a relatively thick electrolyte layer 410. In particular, the anode support 320 may have a thickness T5 ranging from about 20 μm to about 100 μm, such as from about 25 μm to about 75 μm, or from about 40 μm to about 60 μm. The electrolyte layer 410 may have a thickness T6 ranging from about 20 μm to about 80 μm, such as from about 30 μm to about 70 μm, or from about 40 μm to about 60 μm. The relatively thick electrolyte layer 410 may be self-supporting. As such, the thickness of the anode support 320 may be reduced, as compared to the anode support 320 of the cell 400, without compromising cell strength.

In some embodiments, the electrolyte layer 410 may be a ceramic electrolyte, such as SSZ, YSZ, YCSZ or YbCSSZ. In one embodiment, the electrolyte layer 410 may be any of the electrolyte layers 100-100C described above with respect to FIGS. 2A-3C.

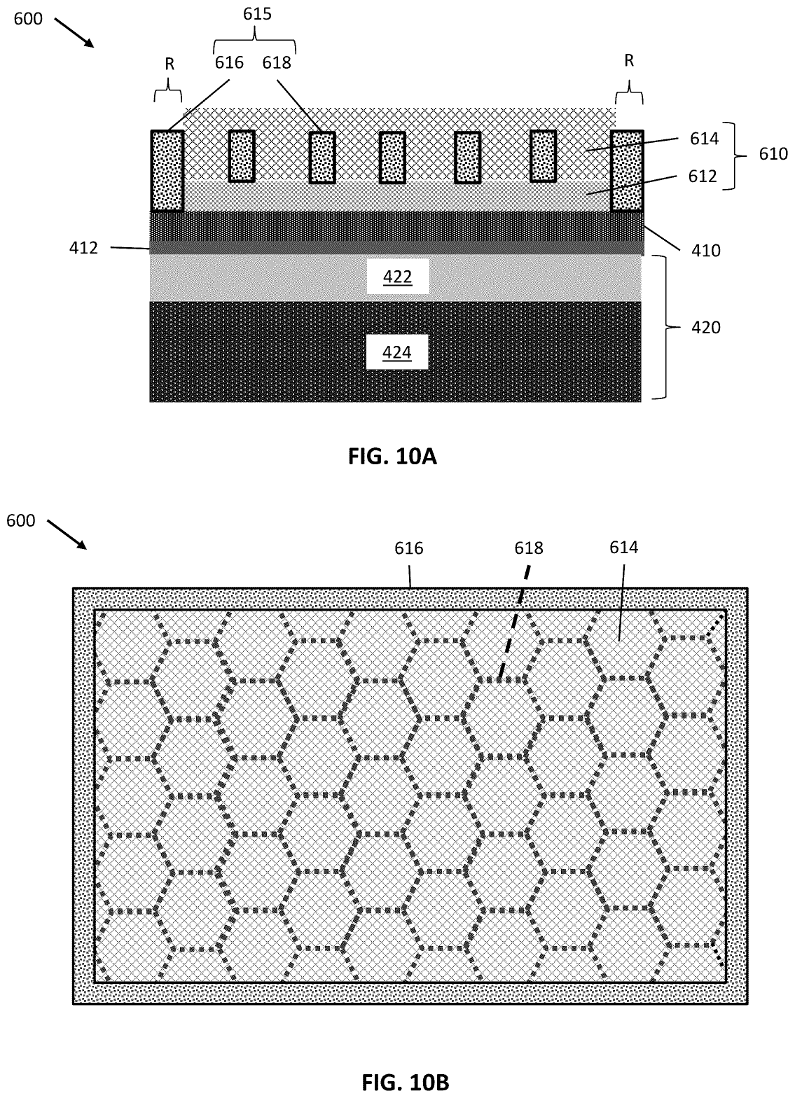

FIG. 9 is a flow diagram depicting method steps for forming an electrochemical cell, according to various embodiments of the present disclosure. Referring to FIGS. 5A, 5B, 6, and 9, in step 802 an anode support material, such as 3-4 molar YSZ, may be coated on a support to form ribs or stripes. For example, the support material may be deposited using a slot-die coating method. Slot-die coating is a ceramic casting technique that uses slurries similar to tape-casting, but with a die-extrusion head hovering above a carrier or web, which may be formed of a polymer film, such as biaxially oriented polyethylene terephthalate film, for example. The die is pressurized, a volumetric flow rate is determined, and a carrier speed is set, to precisely control the wet thickness of the stripes. Ribs may be formed by placing shims into the die, allowing the support material to come out in pre-defined widths.

In step 804, an anode support tape may be formed. In particular, a cermet matrix material, such as Ni-YSZ, for example Ni-3-4YSZ, may be deposited on the anode support material so as to cover the ribs and fill spaces therebetween. For example, the cermet matrix material may be tape-cast using a doctor blade gap that is slightly larger than the dry thickness of the ribs, such that the matrix material is deposited between and on top of the ribs. In particular, covering the ribs may reduce electrical resistance when connecting an anode support to other cell components, such as a nickel mesh.

In step 806, a green-state anode support 320 may be fabricated using the anode support tape. In particular, the anode support tape may be cut to form support layers 330, 340. One of the support layers 330, 340 may be rotated 90° and stacked on the other of the support layers 330, 340 to form the anode support 320. The polymer substrates may also be removed during the stacking process. In some embodiments, one of the support layers 330, 340 may be inverted, such that a tape-side surface of the first support layer 330 contacts a tape-side surface of the second support layer 340 in the anode support 320.

In step 808, additional green-state device layers may be stacked on the anode support 320. In particular, a first FGA layer 312, a second FGA layer 314, an electrolyte layer 410, and an optional barrier layer 412 may be separately cast and then sequentially stacked on the anode support 320. The electrolyte layer 410 may be a single layer or may comprise the electrolyte 100, 100A, 100B, or 100C described above with respect to FIGS. 2A-3C. In some embodiments, some of the above layers may be screen-printed on underlying cast and stacked layers.

In step 810, the stacked layers may be pressed to laminate one or more layers of the stack. The laminated stack may then be sintered at a relatively high temperature. For example, the sintering temperature may range from about 1250° C. to about 1450° C., such as from about 1300° C. to about 1400° C.

In step 812, a cathode electrode 420 may be formed on the sintered stack. In particular, a cathode functional layer 422 and a cathode contact layer 424 may be sequentially printed on the barrier layer 412.

In step 814, the stack may be sintered at a relatively low temperature to form a solid oxide electrochemical cell 400. For example, the sintering temperature may range from about 1000° C. to about 1200° C., such as from about 1050° C. to about 1150° C.

In alternative embodiments, steps 802-806 may be modified to form an anode support 360, as shown in FIGS. 6A and 6B. In particular, the anode support 360 may be formed using a gravure roller to form a support grid 362 on a support or web. The conductive matrix 350 may be deposited on the support grid 362 by tape-casting using a doctor blade, for example. Steps 808-814 may be performed using the anode support 360.

A frame sealing gasket or a nested interconnect may be used in order to seal the anode side of anode supported cells in a fuel cell stack. However, such sealing increases the complexity of the sealing process and adds extra thickness and cost to a fuel cell stack. Anode supported cells may also have low tolerance to redox cycling. When a redox cycle occurs (such as fuel cut off or abnormal system shutdown), the nickel in the anode oxidizes rapidly and undergoes a large volume expansion, which may introduce tremendous stress to the anode electrode and/or result in cracking of the fuel cell.

In an attempt to address such problems, fuel cell systems may include protective systems, such as backup fuel supply and/or safety gas systems, in order to prevent nickel oxidation during emergency shut-down situations. Such protective systems require additional system components that increase system costs. In addition, such protective systems also increase operating costs, since such systems require periodic examination to insure functionality, as well as the routine replacement of safety gases and backup fuel.

Another concern is manufacturing difficulties. Anode supported cells (in which the anode is thicker than the electrolyte) and co-supported cells (in which the thickness ratio of electrolyte to anode is closer to 1:1) can be formed by laminating multiple cell layers, followed by cofiring of the layers. Due to the different characteristics of the layers, shrinkage mismatch and coefficient of thermal expansion (CTE) mismatch are common issues that may require significant engineering effort to solve. In some cases, cell camber or waviness may be unavoidable. In addition, the layer lamination processes used to form anode supported cells may be very time consuming and can represent a rate limiting step during mass production. For example, to ensure cell quality, alignment, bagging, sealing, loading, and pressurization steps may be required by in cells formed by iso-static lamination processes. As a result, batch times of up to one hour may be required.

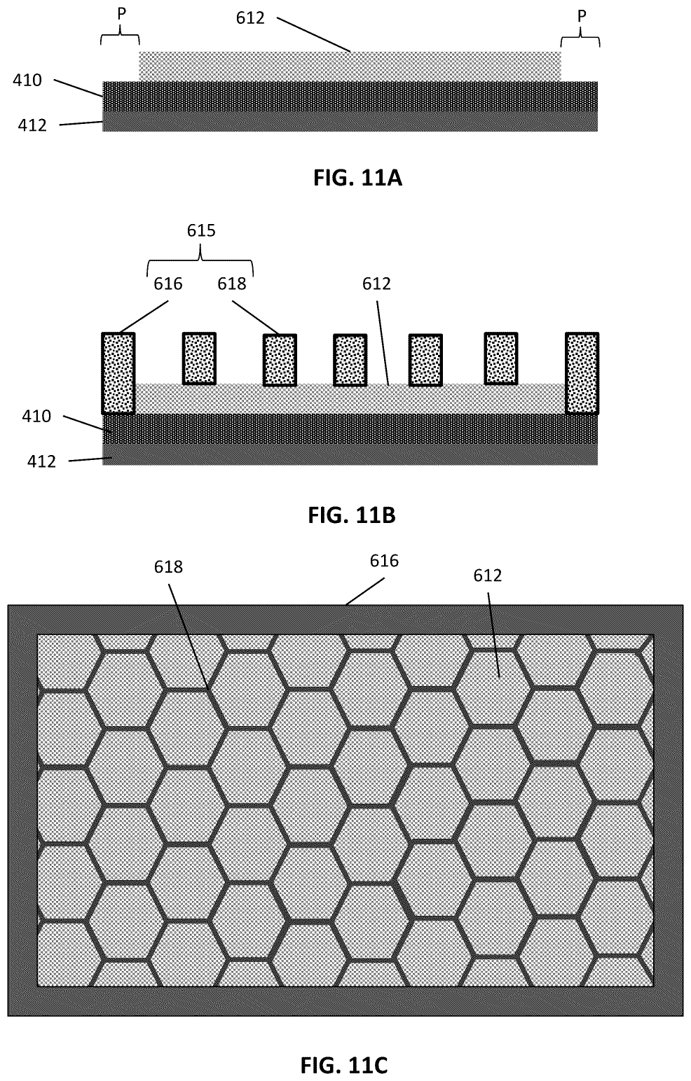

FIG. 10A is a cross-sectional view of an anode supported solid oxide electrochemical cell (e.g., SOFC or SOEC) 600, according to various embodiments of the present disclosure. FIG. 10B is an anode-side (i.e., fuel side) view of the electrochemical cell 600 of FIG. 10A. Referring to FIGS. 10A and 10B, the electrochemical cell 600 includes the electrolyte layer 410, the optional barrier layer 412, and the cathode electrode 420, as described above with regard to FIG. 7, for example. The optional barrier layer 412 may comprise a doped ceria layer, such as a gadolinia or scandia doped ceria (GDC or SDC) layer. The electrochemical cell 600 also includes an anode electrode 610 that is internally supported by a ceramic anode support 615.

The anode electrode 610 may include a nickel containing phase and an ionically conductive ceramic phase, such as ScSZ, YSZ, or doped ceria, as described above. The anode electrode 610 may be a single or multi-layer structure disposed on the electrolyte layer 410. For example, the anode electrode 610 may include a first functionally graded anode (FGA) layer 612 disposed on a first surface of the electrolyte layer 410, and a second FGA layer 614 disposed on the first FGA layer 612. The first FGA layer 612 may include a lower ratio of the nickel containing phase to the ionically conductive phase than the second FGA layer 614. In other words, the second FGA layer 614 may have a higher nickel content than the first FGA layer 612. In another embodiment, the second FGA layer 614 may have a higher porosity than the first FGA layer 612, as described in U.S. Patent Application Publication US 2008/0096080 A1, which is incorporated herein by reference in its entirety.

The ceramic anode support 615 may include a seal frame 616 and an anode reinforcement structure 618. The seal frame 616 may be disposed on the perimeter of the electrolyte 410 and may at least partially surround and/or seal the anode electrode 610. For example, the seal frame 616 may completely cover sidewalls of the first FGA layer 612 and may partially cover sidewalls of the second FGA layer 614. Accordingly, the seal frame 616 may be configured to block a fuel leakage path out of the anode electrode 610.

An upper surface of the seal frame 616 may be disposed below the upper surface of the anode electrode 610, such as below the upper surface of the second FGA layer 612 of the anode electrode 610. As such, a seal recess R (e.g., seal landing area) is formed above the seal frame 616 and outside of the perimeter of the anode electrode 610. The seal recess R may be configured to accommodate a glass, ceramic, or glass/ceramic seal material, which may be applied as a paste or gasket. Accordingly, the electrochemical cell 600 may be incorporated and sealed in a fuel cell stack without the use of specialized frame seals.

The reinforcement structure 618 may internally support the anode electrode 610. The reinforcement structure 618 may have an open cell structure. For example, the reinforcement structure 618 may have hexagonal cells (e.g., a honeycomb pattern). However, the reinforcement structure 618 may have any suitable open cell structure. For example, the reinforcement structure 618 may include circular, ovoid, triangular, rectangular, or polygonal open cell structures.

In some embodiments, the reinforcement structure 618 may be disposed directly on the upper surface of the first FGA layer 612 and may be disposed within (i.e., surrounded by) the second FGA layer 614. For example, the second FGA layer 614 may fill the cells of the reinforcement structure 618. However, in other embodiments, the reinforcement structure 618 may extend through both the first and second FGA layers 612, 614.

The anode support 615 may be made of dense and mechanically strong material. For example, the seal frame 616 and/or the reinforcement structure 618 may include a ceramic material, such as yttria stabilized or partially stabilized zirconia (YSZ and PSZ) (including tetragonal zirconia (commonly referred to as TZP or tetragonal zirconia polycrystal, which is zirconia containing 3-8% yttria)), scandia stabilized zirconia (ScSZ), ceria-zirconia solid solution (CeO2-ZrO2), samaria doped ceria (SDC), alumina (Al₂O₃), combinations thereof, or the like. The seal frame 616 and the reinforcement structure 618 may include the same or different materials. In some embodiments, the anode support 615 may comprise three to four molar percent yttria stabilized zirconia (YSZ) or three to four molar percent yttria stabilized zirconia (YSZ) blended with 2 to 5 mol percent alumina.

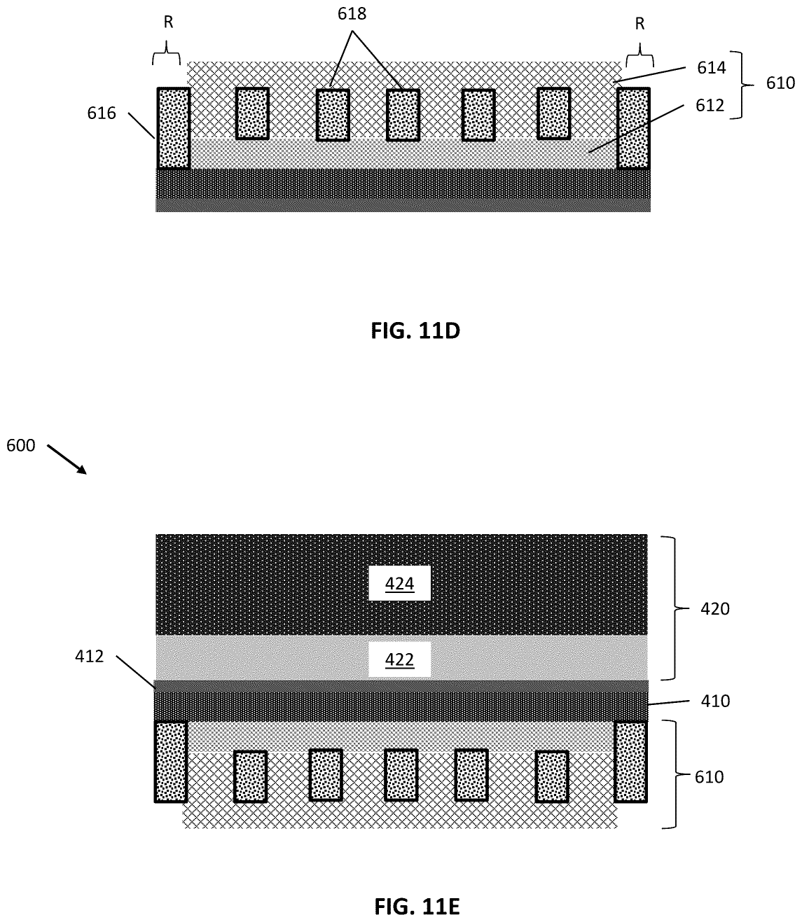

FIGS. 11A-11E are cross-sectional and anode-side views illustrating a method of forming the electrochemical cell 600 of FIG. 10A, according to various embodiments of the present disclosure. Referring to FIG. 11A, the first FGA layer 612 may be formed on a first side of an electrolyte layer 410. The first FGA layer 612 may be formed by any suitable coating or casting method, such as screen printing. In one embodiment, the first FGA layer 612 may have a thickness of 10 to 20 microns. However, other thicknesses may also be used. The perimeter of the first FGA layer 612 may be recessed from the perimeter of the electrolyte layer 410, such that a peripheral region P of the first side electrolyte layer 410 is exposed outside of the first FGA layer 612.

In some embodiments, the barrier layer 412 may be located on a second side of the electrolyte layer 410. In one embodiment, the barrier layer 412 is formed on a support by a tape casting or slot die coating method. The barrier layer 412 may comprise any ceramic material described above, such as SDC, and may have a thickness of 2 to 6 microns. However, other thicknesses may also be used. The electrolyte layer 410 is then formed on the barrier layer 412 by a screen printing, tape casting, or slot die coating method. The electrolyte layer may comprise any ceramic material described above, such as YbCSSZ, and may have a thickness of 5 to 50 microns. However, other thicknesses may also be used. The first FGA layer 612 may then be formed on the first side of the electrolyte layer 410. However, in other embodiments, the first FGA layer 612 may be formed on the first side of the electrolyte layer 410 prior to forming the barrier layer 412 on the second side of the electrolyte layer 410 with tape casting, slot die coating, or screen printing. In yet other embodiments, the barrier layer 412 may be omitted.

Referring to FIGS. 11B-11C, an anode support 615 may be formed on the structure of FIG. 11A. In particular, the anode support 615 may be formed on the first FGA layer 612 and on the peripheral portion of the electrolyte layer 410 exposed peripheral region P. For example, the anode support 615 may be formed by a coating, casting, and/or printing process, such as tape casting, slot-die coating, screen printing, stencil printing, or the like. In some embodiments, the anode support 615 may be screen printed and then optionally cured using any suitable curing process to increase rigidity. In some embodiments, a UV-curing process may be used. The anode support 615 may comprise any ceramic material described above, such as 4 to 5 mol percent YSZ and may have a thickness of 50 to 300 microns. However, other thicknesses may also be used. In one embodiment in which the electrochemical cell 600 is an anode supported cell, the anode support 615 is at least ten times thicker than the electrolyte layer 410.

The anode support 615 may include a seal frame 616 covering and disposed on the peripheral region P electrolyte layer 410 and an anode reinforcement structure 618 disposed on the first FGA layer 612. In some embodiments, upper surfaces of the seal frame 616 and the reinforcement structure 618 may be substantially coplanar. The reinforcement structure 618 may have an open cell structure as described above. In some embodiments, the exposed peripheral region may extend around the full perimeter of the fuel cell. In other embodiments, the exposed peripheral region may extend partially around the perimeter of the fuel cell, such as around certain portions of the perimeter of the fuel cell.

Referring to FIG. 11D, a second FGA layer 614 may be formed on the first FGA layer 612 in the open cell regions in the reinforcement structure 618 by any suitable coating, casting, and/or printing process. For example, in some embodiments, the second FGA layer 614 may be formed may be formed by a stencil printing process, such that the second FGA layer 614 fills the open cell structure of the reinforcement structure 618 and extends above the top surface of the seal frame 616 to leave the seal recess R above the seal frame 616. The second FGA layer 614 may be thicker than the reinforcement structure 618 by at least 5 percent, such as by 10 to 30 percent, and may have a thickness of 210 to 400 microns. However, other thicknesses may also be used. In some embodiments, additional thickness (i.e., upper portion) of the second FGA layer 614 located the above the upper plane of the reinforcement structure 618 may be formed by screen printing an additional nickel-rich layer. Thus, the second FGA layer 614 may be formed using two separate deposition steps (e.g., two screen printing steps).

Referring to FIG. 11E, the structure of FIG. 11D may be inverted and a cathode electrode 420 may be formed over the electrolyte layer 410, using any suitable process. The resulting structure may be sintered to complete the electrochemical cell 600. In some embodiments, the structure of FIG. 11D may be sintered prior to forming the cathode electrode 420 and after forming the cathode electrode 420. Thus, in some embodiments, the electrochemical cell 600 may be formed without using a lamination process.

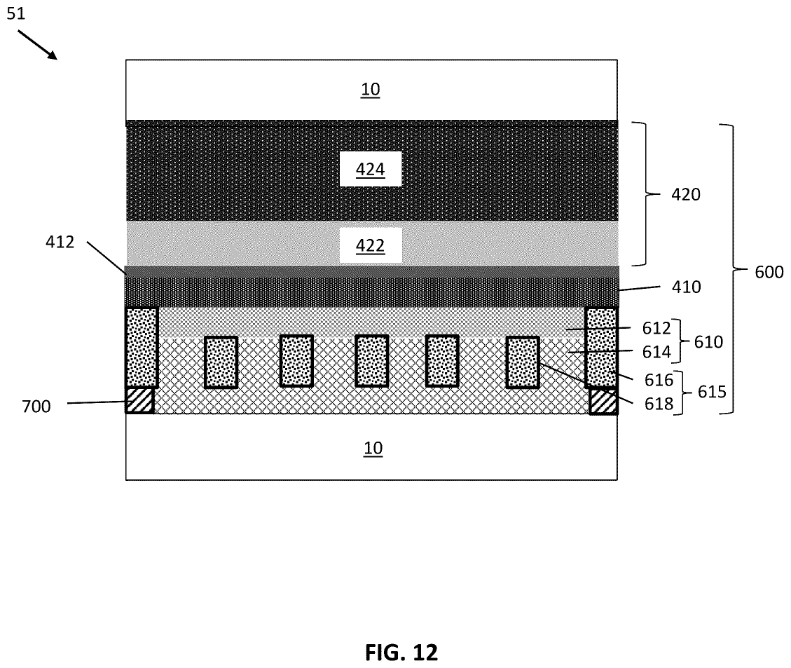

Referring to FIG. 12, a glass or a glass ceramic seal 700 is formed in the seal recess R above the seal frame 616 of the electrochemical cell 600. Alternatively, a gasket seal may be formed instead of the glass or the glass ceramic seal 700. The electrochemical cell 600 and the seal 700 are then placed into an electrochemical cell stack (e.g., a SOFC or SOEC stack) 51 between two interconnects 10. The seal 700 seals the seal frame 616 to the adjacent interconnect 10 to prevent fuel from leaking out between the seal frame 616 and the interconnect 10.

Fuel cell systems of the embodiments of the present disclosure are designed to reduce greenhouse gas emissions and have a positive impact on the climate. Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrochemical cell, comprising:
an anode support comprising:
a cermet matrix comprising a nickel phase and a ceramic phase; and
ceramic support ribs disposed in the matrix;
an anode electrode disposed on the anode support;
an electrolyte layer disposed on the anode electrode; and
a cathode electrode disposed on the electrolyte layer.

2. The electrochemical cell of claim 1, wherein the ceramic support ribs comprise:
first ribs; and
second ribs that extend across the first ribs.

3. The electrochemical cell of claim 2, wherein:
the first ribs are parallel to each other;
the second ribs are parallel to each other and perpendicular to the first ribs; and
the first ribs are located between the second ribs and the anode electrode.

4. The electrochemical cell of claim 1, wherein:
the ceramic support ribs comprise three to four molar percent yttria stabilized zirconia (YSZ) or three to four molar percent yttria stabilized zirconia (YSZ) blended with 2 to 5 mol percent alumina;
the ceramic support ribs comprise less than 0.5 mol % nickel; and
the cermet matrix comprises a nickel-YSZ cermet.

5. The electrochemical cell of claim 1, wherein the electrochemical cell comprises a solid oxide fuel cell.

6. The electrochemical cell of claim 1, wherein the electrochemical cell comprises a solid oxide electrolyzer cell.

7. The electrochemical cell of claim 1, wherein:
the anode support has a thickness ranging from about 75 μm to about 125 μm; and
the electrolyte layer has a thickness ranging from about 4 μm to about 8 μm.

8. The electrochemical cell of claim 1, wherein:
the anode support has a thickness ranging from about 25 μm to about 75 μm; and
the electrolyte layer has a thickness ranging from about 30 μm to about 70 μm.

9. The electrochemical cell of claim 1, wherein the cermet matrix is disposed between the ceramic support ribs and the anode electrode.

10. An electrochemical cell, comprising:
an anode electrode;
a cathode electrode; and
an electrolyte disposed between the anode electrode and the cathode electrode, the electrolyte comprising:
a base layer;
a first support layer disposed on a first surface of the base layer and comprising first apertures that expose portions of the first surface of the base layer; and
a second support layer disposed on a second surface of the base layer and comprising second apertures that expose portions of the second surface of the base layer.

11. The electrochemical cell of claim 10, wherein:
the cathode electrode directly contacts the exposed portions of the first surface of the base layer and covers the first support layer; and
the anode electrode directly contacts the exposed portions of the second surface of the base layer and covers the second support layer.

12. The electrochemical cell of claim 11, wherein the first support layer and the second support layer are laterally offset from each other on the base layer, such that each first aperture overlaps with more than one second aperture.

13. The electrochemical cell of claim 11, wherein the first support layer and the second support layer are laterally aligned on the base layer, such that each first aperture overlaps with only one second aperture.

14. The electrochemical cell of claim 10, wherein the first support layer, the second support layer, and the base layer each comprise a ceramic ionically conductive material.

15. The electrochemical cell of claim 10, wherein the cathode electrode partially fills the first apertures, and the anode electrode partially fills the second apertures.

16. The electrochemical cell of claim 10, wherein the cathode electrode completely fills the first apertures, and the anode electrode completely fills the second apertures.

17. A method of forming an electrochemical cell, comprising:
forming a support by forming ceramic support ribs and forming a cermet matrix between the ceramic support ribs;
forming an anode electrode over the support;
forming a ceramic electrolyte over the anode electrode; and
forming a cathode electrode over the ceramic electrolyte.

18. The method of claim 17, wherein:
the forming the support comprises forming a green-state support;
forming the anode electrode comprises forming a green-state cermet anode electrode; and
forming the ceramic electrolyte comprises forming a green-state ceramic electrolyte.

19. The method of claim 17, further comprising sintering the green-state support, the green-state cermet anode electrode and the green-state ceramic electrolyte prior to forming the cathode electrode over the ceramic electrolyte.

20. The method of claim 19, wherein the forming the green-state support comprises:
forming first green-state ceramic ribs by slot-die coating;
forming a first cermet matrix between the first green-state ceramic support ribs by tape casting to form a first anode support tape;
forming second green-state ceramic ribs by slot-die coating;
forming a second cermet matrix between the second green-state ceramic support ribs by tape casting to form a second anode support tape;
cutting the first anode support tape to form a first support layer;
cutting the second anode support tape to form a second support layer; and
stacking the first support layer on the second support layer such that the first green-state ceramic ribs extend perpendicular to the second green-state ceramic ribs.

21. An electrochemical cell, comprising:
an electrolyte layer;
an anode electrode disposed over a first surface of the electrolyte layer;
a ceramic anode support laterally surrounding the anode electrode and embedded in the anode electrode, wherein a recess configured to receive a seal is located above a periphery of the ceramic anode support; and
a cathode disposed over a second surface of the electrolyte layer.

22. The electrochemical cell of claim 21, wherein the ceramic anode support comprises:
a ceramic seal frame disposed on a peripheral region of the electrolyte layer and laterally surrounding the anode electrode; and
a ceramic reinforcement structure disposed inside of the seal frame and embedded the anode electrode.

23. The electrochemical cell of claim 22, wherein a top surface of the anode electrode is located above a top surface of the seal frame, such that the recess configured to receive the seal is located above the seal frame.

24. The electrochemical cell of claim 22, wherein the anode electrode comprises:
a first functionally graded anode (FGA) layer comprising a first nickel cermet disposed on the top surface of the electrolyte layer; and
a second FGA layer comprising a second nickel cermet disposed on the first FGA layer, the second FGA layer having at least one of a higher nickel content or a higher porosity than the first FGA layer.

25. The electrochemical cell of claim 24, wherein:
the reinforcement structure has an open cell structure and is embedded in the second FGA layer; and
the first FGA layer is located between the reinforcement structure and the first surface of the electrolyte layer.

26. The electrochemical cell of claim 21, wherein:
the ceramic anode support comprises, yttria stabilized zirconia, scandia stabilized zirconia, samaria doped ceria, alumina, ceria-zirconia, or a combination thereof; and
the electrolyte layer comprises a ceramic electrolyte layer.

27. The electrochemical cell of claim 21, wherein the electrochemical cell comprises a solid oxide fuel cell.

28. The electrochemical cell of claim 21, wherein the electrochemical cell comprises a solid oxide electrolyzer cell.

29. The electrochemical cell of claim 21, further comprising a ceramic barrier layer located between the cathode electrode and the electrolyte layer.

30. An electrochemical cell stack comprising:
a first interconnect;
a second interconnect;
the electrochemical cell of claim 22 located between the first interconnect and the second interconnect; and
a glass or a glass ceramic seal or gasket seal located in the seal recess to seal a first interconnect to the seal frame.

31. A method of forming an electrochemical cell, comprising:
forming a first functionally graded anode (FGA) layer over a first surface of an electrolyte layer, such that a peripheral region of the top surface of the electrolyte layer is exposed outside of the first FGA layer;
forming a ceramic anode support comprising a seal frame disposed on the peripheral region of the electrolyte layer and a reinforcement structure disposed on a top surface of the first FGA layer;
forming a second FGA layer on the first FGA layer exposed in the reinforcement structure; and
forming a cathode over a second surface of the electrolyte layer.

32. The method of claim 31, wherein:
the forming the ceramic anode support comprises screen printing a ceramic material on the top surface of first FGA layer and the peripheral region of the electrolyte layer;
the reinforcement structure has an open cell structure; and
the seal frame contacts side surfaces of the first FGA layer and the second FGA layer.

33. The method of claim 32, wherein:
the forming the first FGA layer comprises screen printing a first nickel cermet material over the first side of the electrolyte layer; and
the forming the second FGA layer comprises stencil printing a second nickel cermet material on the top surface of the first FGA layer in the open cells in the reinforcement structure; and
the second nickel cermet material has a higher nickel content than the first nickel cermet material.

34. The method of claim 33, wherein the method excludes a layer lamination process.

35. The method of claim 31, wherein the second FGA layer extends above the seal frame such that a recess is formed above the seal frame.

36. The method of claim 35, further comprising:
forming a glass or a glass ceramic seal in the recess; and
placing an interconnect in contact with the seal.

37. The method of claim 31, wherein:
the ceramic anode support comprises, yttria stabilized zirconia, scandia stabilized zirconia, samaria doped ceria, alumina, ceria-zirconia, or a combination thereof; and
the electrolyte layer comprises a ceramic electrolyte layer.

38. The method of claim 31, wherein the electrochemical cell comprises a solid oxide fuel cell.

39. The method of claim 31, wherein the electrochemical cell comprises a solid oxide electrolyzer cell.

40. The method of claim 31, further comprising forming a ceramic barrier layer on the second surface of the electrolyte layer prior to forming the cathode electrode over the ceramic barrier layer and the second surface of the electrolyte layer.
